(19) United States
(12) Patent Application Publication
(10) Pub. No.: US 2008/0070527 A1
(43) Pub. Date: Mar. 20, 2008

(54) Device for mapping quality of service in a fixed communication network, in particular a high bit rate network

(75) Inventors: Setphane BETGE-BREZETZ, Paris (FR); Gerard DELEGUE, Cachan (FR); Arnaud GONGUET, Paris (FR); Lionel FOURNIGAULT, Gif Sur Yvette (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/532,249

(22) Filed: Sep. 15, 2006

(51) Int. Cl. H04B 1/18

(52) U.S. Cl. 455/187.1

(57) ABSTRACT

A device (D) is dedicated to mapping quality of service in a fixed communication network including communication lines connecting network equipments (Ci) to communication terminals (T) via access points to at least one service (MD). The device (D) comprises i) control means (MC1) adapted to instruct a network management equipment (EG) coupled to the network equipments (Ci) to determine analysis data representative of a selected quality of service and/or a traffic state relating to at least one terminal (T) and/or a network equipment (Ci) situated in at least one selected area of the network, ii) collection means (MC2) adapted to collect in the network management equipment (EG) the analysis data that has been determined, and iii) processing means (MT) adapted to determine the geographical position of terminals (T) and/or network equipments (Ci) situated in a selected area and to which the collected analysis data relates, in order to associate it with the corresponding analysis data, and to deliver in a cartographic form the analysis data associated with the geographical positions of the network equipments and/or terminals situated in each selected area, with a view to the processing thereof.

The invention relates to fixed communication networks, in particular those comprising high bit rate data transmission lines, such as xDSL (x Digital Subscriber Line) type lines, for example, or cables or optical fibers (for example FTTH (Fiber To The Home) type fibers), and more precisely to monitoring quality of service in such networks.

Here “xDSL type lines” means balanced or unbalanced pair digital lines utilizing the unused frequencies of the telephone lines of switched telephone networks (PSTN), and in particular ADSL (Asymmetric DSL), HDSL (High bit rate DSL), RDSL (Rate adaptive DSL), VDSL (Very high bit rate DSL) and SDSL (Single line DSL) connections.

The emergence of broadband services and applications in fixed communication networks (of the type cited above), such as videoconferencing, digital television, telephony, (very) high bit rate Internet, for example, is making it more and more important to monitor quality of service (QoS). It is in fact particularly important that the operators of these networks have access to information enabling them to display clearly the quality of service throughout their network, and in particular the quality of service actually perceived by their customers (or users), if possible as a function of each type of service (video, voice and the like).

Moreover, the operators must frequently change their commercial offers as a function of the changing market and the real requirements of their customers, which requires a good knowledge of the services that are used the most and the associated quality in each portion of their fixed networks. Such knowledge enables the operators to implement localized commercial and advertising policies, for example with the aim of making little used services better known in certain portions of their fixed networks.

In current (high bit rate) fixed networks the quality of service monitoring tools are not sufficiently well adapted to the requirements of the operators cited above. The current tools, such as Concord or Infovista, for example, can in fact display only curves showing the evolution of certain aspects of performance over time, and where appropriate aggregate these aspects of performance in order to obtain quality of service averages for a set of xDSL lines or a concentrator (or DSLAM) or a set of concentrators that broadly define a geographical area within a network.

These curves are undoubtedly necessary, but are not sufficient in fixed networks in particular, which are ceaselessly becoming more complex and more dense. In particular they do not report the overall performance of a fixed network to enable fast and intuitive detection of areas causing problems within a geographical area, a town or a region, followed by complementary analyses, in particular geographical analyses, to determine the causes of the problems.

No known solution proving entirely satisfactory, an object of the invention is therefore to improve upon this situation.

To this end it proposes a quality of service mapping device for a fixed communication network including network equipments at geographical positions that may be determined and through which are connected, via access points to at least one service, communication terminals that are located at geographical positions that can be determined and are part of traffic defined locally by analysis data representative of a quality of service and/or a traffic state.

Here “access point to at least one service” means an equipment or a software module for connecting a terminal and/or a domestic network to a broadband network of an operator. It is therefore typically a modem (for example an ADSL modem) or any other service access equipment/software module (for example a home gateway).

This device is characterized in that it comprises:
control means adapted to instruct a network management equipment coupled to the network equipments (themselves coupled to the access points of the terminals) to determine analysis data representative of at least one selected quality of service and/or a traffic state relating to at least one terminal and/or a network equipment situated in at least one (geographical or administrative) selected area of the network,
collection means adapted to collect in the network management equipment the analysis data determined at the request of the control means, and
processing means adapted to determine the geographical position of terminals and/or network equipments situated in a selected area and to which the collected analysis data relates, then to associate each position determined with the corresponding analysis data, and to deliver in a cartographic form the analysis data associated with the geographical positions of at least some of the network equipments and/or terminals situated in each selected area, with a view to the processing (display and/or analysis) thereof.

The device of the invention may have other features that may be adopted separately or in combination, and in particular:
its control means may be adapted, on the one hand, to program the network management equipment to determine at least some of the analysis data at selected times and in selected areas and, on the other hand, to program the collection means to collect the analysis data each time it has been determined by the network management equipment;
it may comprise man/machine interface means adapted to enable a user to define at least each selected analysis data collection area, each selected area to be mapped, each selected quality of service, each date and/or time of determination of analysis data, and each mapped terminal and/or network equipment;
its collection means may be adapted to store the collected analysis data in corresponding relationship to its collection date and/or time in first memory means accessible to the processing means;
its processing means may be adapted to access second memory means of the network which store local data representative of at least two-dimensional configurations of areas so as to add to the data of a map local data representative of the configuration of a selected area;
its processing means may be adapted to determine the geographical positions of the terminals and/or network equipments from user information and/or network information accessible within the network;
it may comprise browser means adapted to interact with the processing means to enable a user to zoom into a selected portion of a displayed map and/or to add or remove at least one selected network equipment and/or at least one selected terminal from a displayed map and/or to restrict a quality of service that is the subject of a displayed map to a single selected service and/or to add or remove a constraint on selection of analysis data contributing to a displayed map and/or to obtain a map corresponding to a selected date before that of the displayed map and/or a new map representative of a comparison between the displayed map and a map corresponding to a selected earlier (or later) date;
its processing means may be adapted to allocate to at least some of the analysis data that is the subject of a map levels representative of the selected quality of service so that each selected network equipment and/or terminal can be displayed as a function of the level associated with the analysis data that relates to it.

The invention also proposes a network optimization and/or management and/or supervision system comprising, on the one hand, analysis means adapted to analyze analysis data and associated geographical positions delivered in a cartographic form and, on the other hand, a quality of service mapping device of the type described hereinabove adapted to feed the analysis means with analysis data and associated geographical positions.

The invention is particularly well adapted to fixed communication networks including high bit rate data transmission lines, such as xDSL type lines, for example, or cables or optical fibres, connecting access points (such as modems) of terminals to concentrator type network equipments.

Other features and advantages of the invention will become apparent on reading the following detailed description and examining the appended drawings, in which:

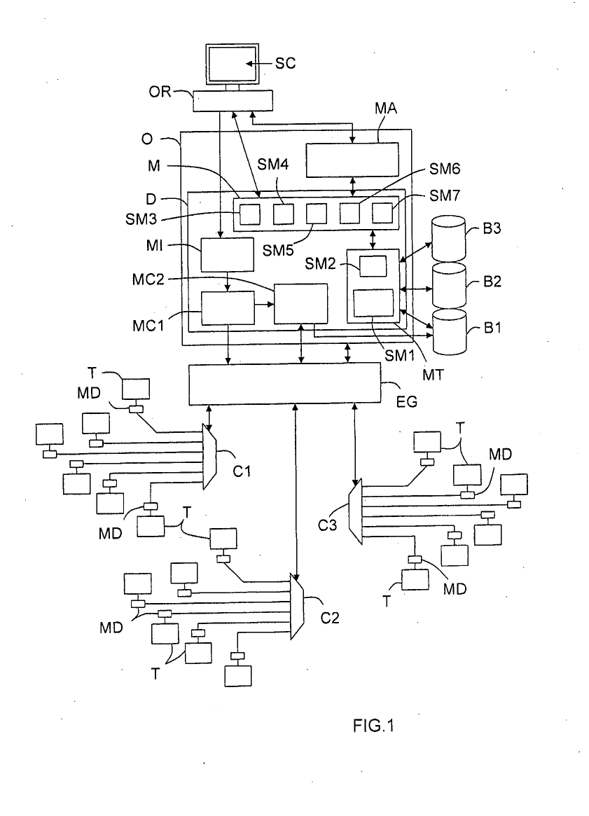

FIG. 1 is a highly schematic illustration of a portion of a fixed communication network comprising a network management equipment coupled to a network optimization and/or management and/or supervision system equipped with one embodiment of a quality of service mapping device according to the invention,

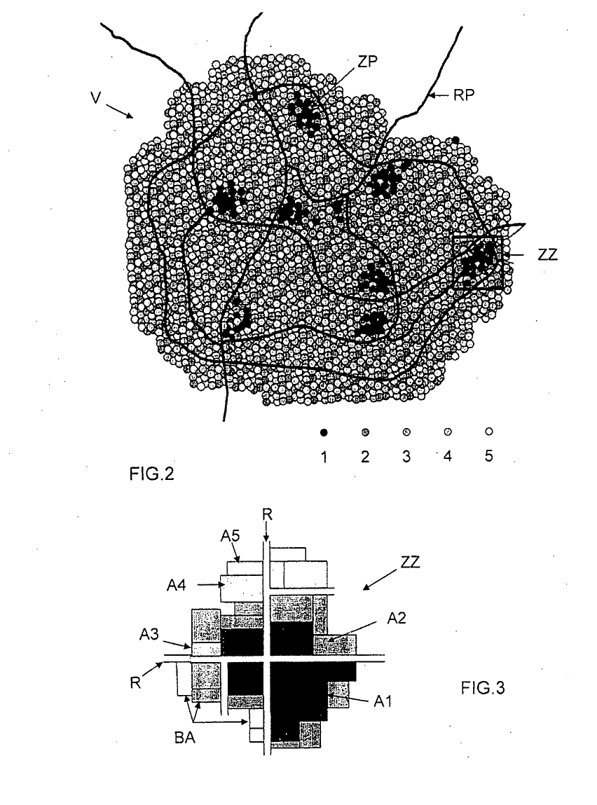

FIG. 2 is a schematic illustration of one example of mapping the quality of service offered by a fixed communication network in a town type geographical area, and

FIG. 3 is a schematic illustration of zooming into a portion (ZZ) of the FIG. 2 map.

The appended drawings constitute part of the description of the invention as well as contributing to the definition of the invention, if necessary.

An object of the invention is to enable monitoring of the quality of service actually perceived by fixed communication terminals connected to fixed communication networks via access points (such as modems (modulators/demodulators), for example).

Hereinafter, it is considered by way of nonlimiting example that the fixed communication network includes high bit rate data transmission lines of the xDSL (x Digital Subscriber Line) type. However, the invention is not limited to that application. It relates in fact to all fixed communication networks to which fixed communication terminals are connected via access points (such as modems), and in particular to cable networks and optical (optical fiber) networks.

Moreover, it is considered hereinafter, by way of nonlimiting example, that the fixed communication terminals (referred to hereinafter as “terminals”) are fixed or portable computers equipped with an access point to at least one modem type service. However, the invention is not limited to that application. It relates in fact to all fixed communication terminals that can be connected to a fixed network via an access point to at least one service, and in particular servers, television receivers and devices for receiving coded or uncoded television and/or video programs (such as set-top boxes, live boxes and free boxes, for example, or digital video recorders (PVR (Personal Video Recorders)).

As shown in FIG. 1, a fixed broadband network may, very broadly speaking but nevertheless in sufficient detail for the invention to be understood, be summarized as consisting of (telephone) transmission lines (here of the high bit rate—xDSL type) coupled, on the one hand, to terminals T, possibly via modems (access points) MD, and, on the other hand, to network equipments Ci, of the concentrator Ci type (DSLAM (Digital Subscriber Line Access Multiplexer)), connected to the switches of telephone central offices, interconnected through the intermediary of a core network (not shown).

In the nonlimiting example shown in FIG. 1, the network comprises three xDSL concentrators C1 to C3 (i=1 to 3). However, the suffix i can take any value greater than or equal to one (1).

The fixed network also comprises a network management equipment (xDSL Network Manager) EG coupled to the network equipments, and in particular to the concentrators Ci and to the modems MD in order to be able to obtain analysis data from them.

Here “analysis data” means traffic data or network parameters or indicators relating to quality of service (QoS) and/or to traffic states. This analysis data may be measured or estimated or recovered by the network management system EG. It is generally recovered from the access points MD or from the concentrators Ci, especially if they include a database for storing the analysis data coming from the access points MD connected to them, or even in some cases from the terminals T.

Moreover, here “network equipment (or element)” means any (physical and/or logical) component of a fixed network through which traffic defined locally by one or more parameter or indicator values passes.

To enable monitoring of quality of service within the network, the invention proposes to equip it with a quality of service mapping device D.

As shown in FIG. 1, this device D may form part of a network optimization and/or management and/or supervision system (or tool). OG coupled to the management equipment EG, for example. This is not obligatory, however. It may in fact be coupled to the management equipment EG and/or to a network optimization and/or management and/or supervision system.

It should be remembered at this point that network optimization and/or management and/or supervision systems OG are used to track the changing quality of service (QoS) in certain network equipments (or elements) and generally comprise an analysis module MA for analyzing analysis data in order to diagnose causes of problems, in particular quality of service problems, and for proposing solutions to those problems. In the context of the invention, this analysis module MA is optional, however.

The device D according to the invention comprises at least one control module MC1 coupled to the management equipment EG, a collection module MC2 coupled to the control module MC1 and to the management equipment EG, and a processing module MT.

The control module MC1 has the task of sending instructions to the management equipment EG in order to instruct it to determine analysis data representative of at least one selected quality of service and/or a traffic state relating to at least one terminal T (in fact its modem MD) and/or a network equipment Ci situated in a selected area of the network.

Here “area” means either a geographical area or an administrative area. Moreover, here “geographical area of the network” means any area including at least one terminal T or a network equipment connected to a fixed network that is the subject of quality of service monitoring, regardless of its size. It could be a room in a building, a portion of a building, a set of buildings, a district in a town or a conurbation, a town or a conurbation, a portion of a region, one or more regions, or even one or more countries, for example. Moreover, here “administrative area” means any area defined on the basis of an administrative criterion, such as at least one access point type or version, for example, or at least one concentrator type or version or a set of access points (or concentrators) for which a parameter is greater than or less than a given value.

The instructions may be provided in the form of a file by a computer OR controlled by the operator of the network or generated via a man/machine interface MI from commands and/or instructions supplied by the operator of the network via a computer OR.

As shown in the single FIGURE, this man/machine type interface MI may be installed in the device D. However, this is not obligatory. It could be installed in the optimization and/or management and/or supervision system OG.

Using this kind of man/machine interface MI, the operator can in particular define each area for which analysis data is to be determined, each selected quality of service, each selected service, each selected determination date and/or time, and each terminal T and/or network equipment to which the analysis data to be collected relates. It also makes it possible to define how the management equipment EG should be programmed to determine at least some of the analysis data at selected times and in selected (geographical or administrative) areas. For example, it may be programmed to determine analysis data relating to video transmission services in a portion of or the whole of the fixed network between 6 pm and 11 pm.

This programming is transformed by the control module MC1 into instructions that it transmits to the management equipment EG in order for it to be configured in such a manner as to initiate the determination of the corresponding analysis data.

The collection module MC2 has the task of collecting in the management equipment EG the analysis data that it has determined at the request of the control module MC1. This data is preferably collected at the request of the control module MC1. Consequently, in the event of programming the determination of analysis data, the collection module MC2 may also be programmed by the control module MC1 to collect analysis data each time that such data is determined by the management equipment EG.

The collection module MC2 preferably stores the analysis data that it has collected in first memory means B1 in corresponding relationship to its determination date(s) and/or time(s). These first memory means B1 may take any form, such as a memory or a database, for example (as is the case hereinafter).

As shown in FIG. 1, this first database B1 comprising collected analysis data is preferably external to the device D. This is not obligatory, however. It may in fact form part of the device D or of the optimization and/or management and/or supervision system OG, given that it can use them to effect its own analyses by means of its analysis module MA.

The processing module MT firstly determines the (at least two-dimensional (2D)) geographical positions of the terminals T and/or the network equipments Ci that are situated in each area selected by the operator and to which the collected analysis data relates. It is important to note that these areas are not necessarily those defined by the instructions sent to the management equipment EG. They are in fact areas for which the operator wishes to obtain quality of service maps based on newly or previously collected analysis data.

To determine the geographical position (latitude, longitude and where applicable (in the 3D situation) altitude) of a terminal T or a network equipment Ci, the processing module MT may, for example, access second memory means B2 which stores data representative of information on users and/or network information.

The second memory means B2 may take any form, such as a memory or a database, for example (as is the case hereinafter). As shown in FIG. 1, this second database B2 comprising information data is preferably external to the device D. This is not obligatory, however.

The information that is stored in this second database B2 comprising information data generally defines the type of subscription that a user has entered into and his postal address, and where applicable the corresponding geographical position. If the information on a user relates only to his postal address, the processing module MT deduces the corresponding geographical position therefrom (where applicable by invoking an external “geo-naming” application). The information on the network equipments Ci may be their geographical position, their type or their software version, for example.

Alternatively, the geographical positions of the terminals T and/or the concentrators Ci may where applicable be obtained from said concentrators Ci.

When the processing module MT has determined the geographical position of a terminal T or of an equipment Ci, it associates it with each corresponding item of analysis data (a plurality of newly collected items of analysis data may in fact relate to a network equipment Ci (the same terminal T (indirectly)) or an adjacent access point MD (via specific formulas).

The processing module MT then delivers the analysis data associated with the geographical positions of the network equipments and/or the terminals situated in each selected area in map form. This mapping data may then be displayed on the screen SC of a computer OR or transmitted to the analysis module MA of the optimization and/or management and/or supervision system OG for the latter to analyze it.

The processing module MT may be adapted to access third memory means B3 of the network which store local data representative of the at least two-dimensional configuration of areas. Here “configuration” means information describing the layout of a building or of a set of buildings, a district in a town or a conurbation (for example the respective positions of the buildings and the streets), or a town or conurbation (for example the respective positions of the districts and the main streets or traffic routes).

The third memory means B3 may take any form, such as a memory or a database, for example (as is the case hereinafter). As shown in FIG. 1, this third database B3 comprising information data is preferably external to the device D (it may be the GIS (Geographical Information System) database, for example). This is not obligatory, however.

The processing module MT may add some of this local data to the data of a map in order to enrich it and/or to facilitate its interpretation.

The analysis data generally taking the form of values, the processing module MT may also have the task of transforming at least some of it into levels representative of the selected quality of service. For example, ranges of values are defined that are associated with different levels, for example a gray scale or different colors. Accordingly, each terminal T or network equipment Ci may be displayed as a function of the level that is associated with the analysis data relating to it.

As shown in FIG. 1, the processing module MT may comprise two submodules, for example, the one SM1 being responsible for extracting from the various databases B1, B2 and B3 the information and data necessary for the construction of the quality of service maps, the other SM2 being responsible for filtering the information from the maps in order for it to satisfy the requirements and where applicable display (or export) constraints imposed by the operator. For example, the second sub-module SM2 can hide or show one or more types of network equipments.

Thanks to the processing module MT, the operator can obtain any type of quality of service map on demand, such as a map of the quality of service as a function of a service (video, voice and the like) and/or a type of user, for example, which enables him to orient and refine either his own analyses of the network and the services offered or the analyses effected by the analysis module MA of the optimization and/or management and/or supervision system OG.

To enable the operator to supply his requests and/or his constraints to the processing module MT and to display the resulting maps on a screen SC of a computer OR, the device D preferably comprises a browser module MN.

As shown in FIG. 1, the browser module MN may include one or more sub-modules assigned to different tasks.

For example, a first sub-module SM3 is dedicated to the definition of complex requests (selected mapping (geographical or administrative) area, selected quality of service, selected type of service, selected type of user, type of terminal and/or network equipment, selected date and/or time, and the like), and their transmission to the processing module MT. This first sub-module SM3 can obtain mapping data responding to more complex criteria than those used by the other modules. To this end it uses enriched models. For example, requests are generated using an SQL type language that enables sophisticated filtering. For example, the operator can generate a request to display all the access points MD of a given type for which the quality of service associated with a given parameter is above a given threshold.

A second sub-module SM4 may be dedicated to zooming requests, for example. This function is particularly useful when the operator has seen a quality of service problem in a mapped area, since it can increase the level of detail of the map by “zooming” into the area portion in which the problem has been located.

A situation of this kind is shown diagrammatically in FIGS. 2 and 3 in the case of a town V. Here, FIG. 2 shows a quality of service map in a town V, associating with each terminal T situated within the perimeter of the town V a circle that shows its geographical position relative to the main road axes RP (defined in the third database B3 comprising information data) and assigning five different shades of gray (1 to 5 in the key) as a function of the value of the quality of service associated with the terminal T.

In this example of a quality of service map there can be seen eight areas ZP in which the proportion of terminals T receiving a very poor quality of service (in black—level 1) is high. By zooming into one of these areas, for example the area ZZ, using the second sub-module SM4, the map shown in FIG. 3 is obtained. As may be seen, the level of detail is considerably increased. There are now seen all the main buildings BA and all the streets R. Each building BA is associated here with a shade of gray A1 to A5 because it comprises a plurality of terminals having the same quality of service value.

This zooming operation is effected by the processing module MT at the request of the second sub-module SM4 of the browser module MN. It necessitates the recovery of information data in the third database B3 and filtering of the mapping data that relates to the area portion that is the subject of the zoom.

A third sub-module SM5 may be dedicated to adding or removing a selected network equipment (or equipment type), for example the concentrators Ci, and/or a selected terminal T (or type of terminal or user) in a displayed map, for example.

This addition or removal operation is effected by the processing module MT at the request of the third sub-module SM5 of the browser module MN. It necessitates new filtering of the data of the area that is the subject of the map and/or the possible recovery of information data in the second database B2 and/or the third database B3.

A fourth sub-module SM6 may be dedicated to restricting a quality of service that is the subject of a displayed map to a selected single service and/or to adding or removing a selection constraint in respect of the analysis data contributing to a displayed map, for example.

This restriction and/or addition or removal operation is effected by the processing module MT at the request of the fourth sub-module SM6 of the browser module MN. It necessitates new filtering of the data of the area that is the subject of the map.

A fifth sub-module SM7 may be dedicated to displaying a map corresponding to a selected date before that of a displayed map and/or to a new map representative of a comparison between a displayed map and a map corresponding to a selected earlier (or later) date, for example.

This operation of renewing the display and/or comparison of maps is effected by the processing module MT at the request of the fifth sub-module SM7 of the browser module MN. It necessitates a recovery of information data in the first database B1 and/or the second database B2 and/or the third database B3 and new filtering of the area that is the subject of the map. For example, a comparison of maps may consist in establishing the difference between the quality of service values of the points constituting the area that is the subject of the map and then constructing the map of the differences for the area concerned, with a view to its display on the screen SC.

The quality of service mapping device D of the invention, and in particular its processing module MT, control module MC1 and collection module MC2, and where applicable its interface module M1 and browser module MN, may be implemented in the form of electronic circuits, software (or electronic data processing) modules or a combination of circuits and software.

The invention offers advantages including:
the generation of quality of service maps enabling an operator quickly to obtain an overview of the performance of his network and to perform in-depth analyses by means of graphical requests,
the entirety of a network or only a portion thereof may be automatically mapped and where applicable updated continually at lower cost,
it provides mapping data that may be used to correlate graphically quality of service problems with causes of problems (so-called “root” causes),
it enables the operator to control the determination of analysis data in order to avoid overloading his network (the number of areas subject to mapping, despite the number of measurements effected, may in fact be controlled).

The invention is not limited to the quality of service mapping device and network optimization and/or management and/or supervision system embodiments described hereinabove by way of example only, and encompasses all variants that the person skilled in the art might envisage within the scope of the following claims.

1-11. (canceled)

12. A quality of service mapping device for a fixed communication network comprising communication lines connecting network equipment to communication terminals via access points to a service, the network equipments and terminals having geographical positions that can be determined and being involved in traffic defined locally by analysis data representative of a quality of service and/or of a traffic state, which device comprises:
control means adapted to instruct a network management equipment coupled to said network equipment to determine analysis data representative of a selected quality of service and/or a traffic state relating to a terminal and/or a network equipment situated in a selected area of the network,
collection means adapted to collect in said network management equipment said analysis data determined at the request of said control means, and
processing means adapted to determine the geographical position of terminals and/or network equipment situated in a selected area and to which the collected analysis data relates, then to associate a position determined with the corresponding analysis data, and to deliver in a cartographic form the analysis data associated with the geographical positions of at least some of the network equipment and/or terminals situated in a selected area, in view of a processing thereof.

13. A device according to claim 12, wherein said control means are adapted to program said network management equipment to determine at least some of said analysis data at selected times and in selected areas and to program said collection means to collect said analysis data determined by said network management equipment.

14. A device according to claim 12, comprising man/machine interface means adapted to enable a user to define a selected analysis data collection area, a selected area to be mapped, a selected quality of service, a date and/or time of determination of analysis data, and a mapped terminal and/or network equipment.

15. A device according to claim 12, wherein said collection means are adapted to store said collected analysis data in corresponding relationship to its collection date and/or time in first memory means accessible to said processing means.

16. A device according to claim 12, wherein said processing means are adapted to access second memory means of the network which store local data representative of at least two-dimensional configurations of areas so as to add to the data of a map local data representative of the configuration of a selected area.

17. A device according to claim 12, wherein said processing means are adapted to determine said geographical positions of the terminals and/or network equipments from user information and/or network information accessible within said network.

18. A device according to claim 12, comprising browser means adapted to interact with said processing means to enable a user to zoom into a selected portion of a displayed map and/or to add or remove a selected network equipment and/or a selected terminal from a displayed map and/or to restrict a quality of service that is the subject of a displayed map to a single selected service and/or to add or remove a constraint on selection of analysis data contributing to a displayed map and/or to obtain a map corresponding to a selected date before that of the displayed map and/or a new map representative of a comparison between the displayed map and a map corresponding to a selected earlier date.

19. A device according to claim 12, wherein said processing means are adapted to allocate to at least some of the analysis data that is the subject of a map levels representative of the selected quality of service so that a selected network equipment and/or terminal can be displayed as a function of the level associated with the analysis data that relates to it.

20. A network optimization and/or management and/or supervision system comprising analysis means adapted to analyze analysis data and associated geographical positions delivered in a cartographic form and a quality of service mapping device according to claim 12 adapted to feed said analysis means with analysis data and associated geographical positions.

21. Use of quality of service mapping device and network optimization and/or management and/or supervision system according to claim 12 in networks including high bit rate data transmission lines.

22. Use according to claim 21, wherein said lines are selected from a group comprising xDSL type lines, cables and optical fibers connecting network equipments of concentrator type to access points to at least one service connected to fixed communication terminals.
